(19) United States
(12) Patent Application Publication
(10) Pub. No.: US 2026/0235223 A1
(43) Pub. Date: Aug. 13, 2026

(54) ACTUTAOR MECHANISM FOR AUTOMATION TECHNOLOGY

(71) Applicant: AUMA Riester GmbH & Co. KG, Müllheim (DE)

(72) Inventors: Marc HISS, Krozingen (DE); Vladimir FICHTE, Nürnberg (DE)

(73) Assignee: AUMA Riester GmbH & Co. KG, Müllheim (DE)

(21) Appl. No.: 19/155,705

(22) PCT Filed: Mar. 15, 2024
(86) PCT No.: PCT/EP2024/056994

§ 371 Date: Aug. 12, 2025

(30) Foreign Application Priority Data
Mar. 15, 2023 (DE) 10 2023 106 532.7

(51) Int. Cl. F16K 31/04; F16K 31/05; F16K 31/53

(52) U.S. Cl. CPC F16K 31/048; F16K 31/05; F16K 31/53

(57) ABSTRACT

An actuator mechanism for automation technology having a torque-limiting device which limits a torque transmissible from a motor and/or a manual drive of the actuator mechanism to an output of the actuator mechanism. The torque limitation is effected by an intermediate element which is arranged between a toothed part and a toothed part carrier.

### CROSS-REFERENCE TO RELATED APPLICATIONS

This application is a 371 National Phase of International Application No. PCT/EP2024/056994, filed Mar. 15, 2024, which claims priority from German Patent Application No. 10 2023 106 532.7, field Mar. 15, 2023, both of which are incorporated herein by reference as if fully set forth.

### TECHNICAL FIELD

The invention relates to an actuator mechanism for automation technology.

### BACKGROUND

Actuator mechanisms are well known, for example from DE 10 2009 054 120 B4, and are used, for example, to operate fittings such as valves. In many cases, electric motors are used, which are controlled by control electronics to operate fittings. However, there are also applications in which fittings are operated manually. In all cases, there is a possibility that a fitting may be moved to an end position with too much force or torque. For example, manual operation provides poor control over the force applied. In the case of motorized operation, torque surges may occur under certain operating conditions or if the torque cut-off is faulty. There is therefore a risk of damage to fittings.

U.S. Pat. No. 8,015,890 B2 discloses a linear actuator mechanism which is characterized in that the overload clutch is arranged in connection with a first stage or one of the first stages in the reduction gear, whereby the overload clutch is not exposed to such high torque loads, allowing it to be designed more compactly and reliably. The lower torque load also allows the speed of the drive to be increased compared to the known design by selecting spindles with larger pitches.

A motor device for driving a ball valve is known from CN 207 750 563 U.

A device is already known from EP 0 383 915 A1 which is intended for controlling actuating mechanisms with a progressive rod movement of these mechanisms and, in particular, for electric drives with a reserve manual drive for controlling pipe fittings. This device can be used most advantageously in the chemical and petroleum processing industries, in the gas, pulp and paper industries, in nuclear power plants, in ferrous and non-ferrous metallurgy, and in other branches of industry.

### SUMMARY

It is therefore the object of the invention to propose an actuator mechanism that enables the safe operation of a fitting.

The object is solved by an actuator mechanism having one or more of the features disclosed herein.

An actuator mechanism according to the invention for automation technology comprises
a manual drive with a manual drive shaft and/or an electric motor with a motor drive shaft;
an output with an output shaft designed for adjusting and/or operating a fitting;
wherein a transmission of torque from the manual drive shaft and/or the motor drive shaft to the output shaft is effected by a gear of the actuator mechanism,
wherein the gear has a plurality of toothed parts, such as gearwheels or worms, and toothed part carriers assigned to the toothed parts, such as gear shafts or gear axles,
wherein the actuator mechanism comprises a torque-limiting device, which torque-limiting device is designed to define or establish an upper limit of the torque transmissible from the manual drive shaft and/or the motor drive shaft,
wherein the torque-limiting device is formed by:
at least one assembly comprising a toothed part with an associated toothed part carrier, wherein at least one positive limiting connection is provided between the toothed part and the associated toothed part carrier,
wherein the positive limiting connection is provided in each case by force engagement,
wherein, upon reaching a limit torque, the positive connection is released,
wherein the at least one positive limiting connection is matched to the upper limit of the torque to be transmitted,
wherein, in at least one assembly of the at least one assembly, the force connection between the toothed part and the toothed part carrier is mediated by at least one intermediate element,
wherein each intermediate element is in contact with the toothed part and the toothed part carrier and is of annular design,
wherein a toothed part has a longitudinal axis and a through bore extending along the longitudinal axis, which through bore defines an inner lateral surface of the toothed part, wherein the inner lateral surface of an associated toothed part carrier surrounds the toothed part,
wherein, in at least one of the assemblies, the inner lateral surface of a toothed part is spaced apart from an outer surface of an associated toothed part carrier,
wherein the at least one annular intermediate element is arranged between the outer surface and the inner lateral surface and is in contact with both the inner lateral surface and the outer surface, and
wherein the limiting connection is effected between the intermediate element and the inner lateral surface or between the intermediate element and the outer surface.

The coordination of the positive limiting connection can be achieved, for example, by suitable selection of material parameters such as the coefficient of static friction.

Intermediate elements have the advantage that they can be obtained inexpensively as standard components, for example.

This prevents forces and torques transmitted to a fitting from impairing the function of the fitting. This is particularly advantageous for small and/or fragile valves, such as flange types F07, F05, or F03. For example, with small flange sizes for rotary and swivel actuators in accordance with ISO 5210 08/2017 or ISO 5211 08/2017, the values for maximum output torques at the actuator mechanism are in some cases significantly less than 40 Nm. This means that there is a risk of these values being exceeded with a manual drive, which could damage the fitting.

The adjustment of a fitting can include, for example, closing or opening a valve or gate valve, or moving to an intermediate position.

In one design, at least one of the assemblies has a plurality of intermediate elements.

For example, an upper limit of the torque that can be transmitted by the manual drive shaft and/or the motor drive shaft can then be defined by selecting a number of the intermediate elements used.

In one design, at least two assemblies are provided, each with different toothed part carriers.

This provides a redundant torque upper limit device. If, for example, a positive limiting connection fails in one of the assemblies, for example due to rusting, a torque upper limit is ensured by another of the assemblies.

In one design, at least one assembly of the at least one assembly is arranged on the manual drive shaft and/or the motor drive shaft, which acts as a toothed part carrier.

In one design, the positive connection can be adjusted by setting a product of contact pressure, contact surface, and coefficient of static friction between contacting materials.

The coefficient of static friction can also be adjusted or influenced by a lubricant such as grease or oil.

In one design, the manual drive shaft has a connection for a manual operating element, wherein the manual operating element is, for example, a hand wheel or a wrench.

In one design, the actuator mechanism has a housing, wherein the drive shaft, output shaft and gear are each arranged at least partially within the housing.

### BRIEF DESCRIPTION OF THE DRAWINGS

The invention is described below with reference to exemplary embodiments.

FIG. 1 shows an example of an actuator mechanism according to the invention;

FIG. 2 shows an exploded view of an assembly shown in FIG. 1;

FIG. 3 shows a longitudinal sectional view of an exemplary assembly according to the invention.

### DETAILED DESCRIPTION

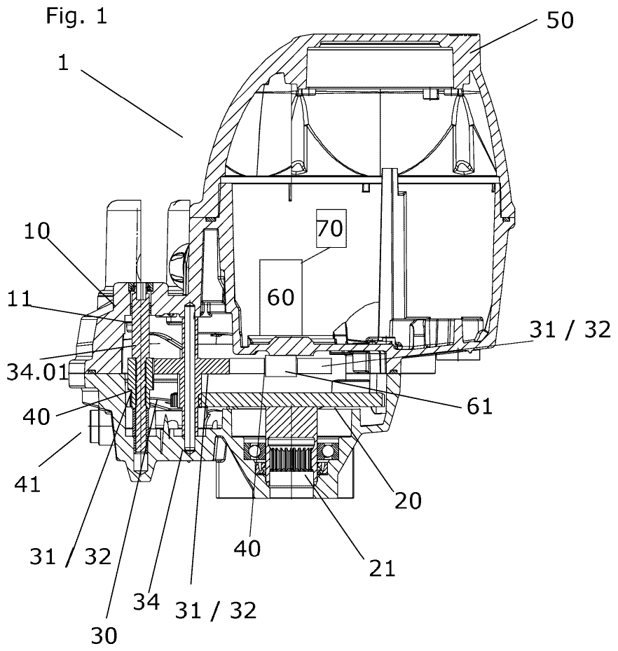

FIG. 1 schematically illustrates an exemplary actuator mechanism 1 according to the invention, comprising a manual drive 10 with a manual drive shaft 11, an output 20 with an output shaft 21, and a gear 30 which is designed by means of toothed parts 31 for transmitting a torque of from the manual drive shaft to the output shaft. For the purpose of operating the manual drive, a manual control element 12, such as a hand wheel or a wrench, can be connected via a connection of the manual drive. As shown here, the actuator mechanism can have an electric motor 60 with a motor drive shaft 61 as an alternative to the manual drive or in addition to it, which is connected to the gear 30 or directly to the output to drive it. Typically, a housing 50 is provided, in which the drive shaft, output shaft, and gear are each at least partially arranged. The toothed parts can be, for example, gearwheels 32 or worms. Toothed part carriers can be gear shafts 34.01 or gear axles, as shown here. An electronic operating circuit 70 is designed to operate the electric motor 70.

According to the invention, a torque-limiting device 40 is provided which is designed to limit the torque transmitted from the manual drive 10 and/or electric motor 60 via the motor drive shaft 61 to the output. In this way, fragile or sensitive fittings can be protected against excessive torque or forces resulting from such torque. This is particularly advantageous for small and/or fragile fittings, for example, when flange designs F07, F05, or F03 are used. For example, with small flange sizes of rotary and swivel actuators in accordance with standards ISO 5210 08/2017 and ISO 5211 08/2017, the values for maximum output torques at the actuator mechanism are in some cases significantly less than 40 Nm. This means that there is a risk of these values being exceeded with a manual drive and electric motor, which could damage the fitting. The electric motor and motor drive shaft 61 can be offset to the section plane of the graphic as shown here.

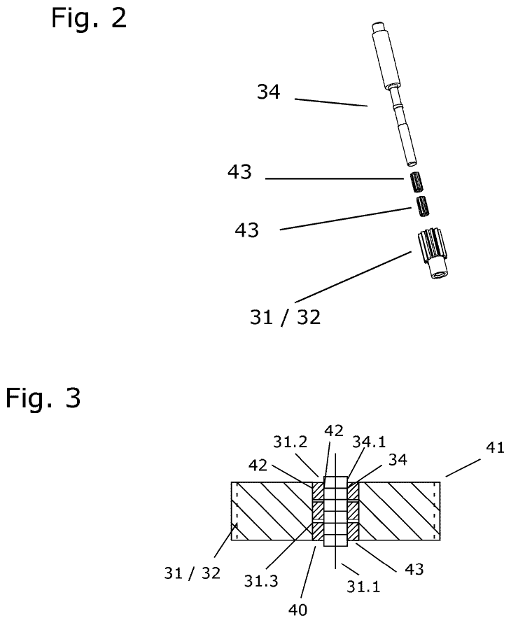

A torque-limiting device according to the invention comprises, as shown here and in the exemplary exploded view shown in FIG. 2, an assembly 41 comprising a toothed part 31, such as a gearwheel 32, an associated toothed part carrier 34, wherein at least one positive limiting connection 42, here for example two positive limiting connections 42, are provided between the gear and the associated toothed part carrier. The torque limitation results from the fact that when a maximum static friction force is exceeded, two contacting surfaces of the limiting connection begin to slide against each other. As shown here, at least one ring-shaped intermediate element 43 is arranged between a toothed part and a toothed part carrier for the purpose of establishing the force-fitting connection; in this example, two intermediate elements 43 are arranged, which are located in a press fit between the toothed part and the toothed part carrier.

FIG. 3 shows a longitudinal section through an exemplary design of an assembly 41 of a torque-limiting device 40, wherein three intermediate elements 43 are arranged between the toothed part carrier 34 and the toothed part 31, as shown here for example, which cooperate in the limiting connection 42. The toothed part 31, here for example a gearwheel 32, has a longitudinal axis 31.1 and a through bore 31.2 extending along the longitudinal axis, which through bore defines an inner lateral surface 31.3 of the toothed part, wherein the inner lateral surface surrounds the associated toothed part carrier 34 with an outer surface 34.1.

The inner lateral surface 31.3 of the toothed part is spaced apart from the outer surface 34.1 of the associated toothed part carrier 34, wherein the at least one annular intermediate element 43 is arranged between the outer surface and the inner lateral surface and is in contact in each case with both the inner lateral surface and the outer surface. The at least one limiting connection 42 is formed between the intermediate element and the inner lateral surface or between the intermediate element and the outer surface.

The maximum torque limit can be set by selecting a maximum static friction of the at least one force-fitting limiting connection. For example, when using intermediate elements, a maximum torque limit can be set via the number of intermediate elements. Multiple intermediate elements arranged between a toothed element and an associated toothed part carrier act in parallel. With a larger number, the maximum static friction force between the toothed element and the toothed part carrier increases, and thus the torque limit. When standard parts are used as intermediate elements, the torque limit can be set inexpensively and without great effort.

The features shown in FIGS. 1 to 3 can be combined.

### LIST OF REFERENCE SIGNS

1 Actuator mechanism
10 Manual drive
11 Manual drive shaft
12 Manual control element
20 Output
21 Output shaft
30 Gear
31 Toothed part
31.1 Longitudinal axis
31.2 Through bore
31.3 Inner lateral surface
32 Gearwheel
34 Toothed part carrier
34.01 Gear shaft
34.1 Outer surface
40 Torque-limiting device
41 Assembly
42 Positive limiting connection
43 Intermediate element
44 Shaped elements
45 Encompassing area
50 Housing
60 Electric motor
61 Motor drive shaft
70 Electronic operating circuit

1. Actuator mechanism (1) for automation technology, comprising:
a manual drive (10) with a manual drive shaft (11) and/or an electric motor (60) with a motor drive shaft (61);
an output (20) with an output shaft (21) adapted to adjust and/or actuate a fitting;
a gear (30) by which a transmission of torque or force from the manual drive shaft and/or the motor drive shaft to the output shaft is effected,
wherein the gear has a plurality of toothed parts (31) and toothed part carriers (34) assigned to the toothed parts;
a torque-limiting device (40) that is adapted to define an upper limit of the torque transmissible from the manual drive shaft and/or the motor drive shaft,
wherein the torque-limiting device (40) includes by:
at least one assembly (41) comprising a toothed part (31) with an associated toothed part carrier (34), wherein at least one positive limiting connection (42) is provided between the toothed part and the associated toothed part carrier,
the positive limiting connection is provided by force engagement,
wherein, upon reaching a limit torque, the positive connection is released,
the at least one positive limiting connection is matched to the upper limit of the torque to be transmitted;
in at least one said assembly (41) of the at least one assembly, the force connection between the toothed part (31) and the toothed part carrier (34) is mediated by at least one intermediate element (43),
the intermediate element is in contact with the toothed part and the toothed part carrier and is annular,
said toothed part (31) has a longitudinal axis (31.1) and a through bore (31.2) extending along the longitudinal axis, said through bore defines an inner lateral surface (31.3) of the toothed part, wherein the inner lateral surface surrounds an associated toothed part carrier (34),
in at least one of the assemblies (41) of the at least one assembly, the inner lateral surface (31.3) of the toothed part is spaced apart from an outer surface (34.1) of the associated toothed part carrier (34),
wherein the at least one annular intermediate element (43) is arranged between the outer surface and the inner lateral surface and is in contact with both the inner lateral surface and the outer surface, and
the at least one positive limiting connection (42) is effected between the intermediate element and the inner lateral surface or between the intermediate element and the outer surface.

2. The actuator mechanism according to claim 1,
wherein at least one of the at least one assembly (41) has a plurality of intermediate elements (43).

3. The actuator mechanism according to claim 1,
wherein the at least one assembly includes two of the assemblies (41) that are each provided with different ones of the toothed part carriers (34).

4. The actuator mechanism according to claim 1
wherein said at least one assembly (41) of the at least one assembly is arranged on the manual drive shaft (11), and the manual drive shaft acts as the toothed part carrier (34).

5. The actuator mechanism according to claim 1
wherein adjustment of the at least one positive limiting connection (42) is settable by adjusting a product of contact pressure, contact surface and coefficient of static friction between contacting materials.

6. The actuator mechanism according to claim 1
wherein the manual drive shaft (11) is provided and has a connection for a manual operating element (12), and the manual operating element is for example, a hand wheel or a wrench.

7. The actuator mechanism according to claim 1, further comprising claims,
a housing (50), and
wherein the manual drive shaft (11) is provided, and the manual driveshaft (11), the output shaft (21) and the gear (30) are each arranged at least partially within the housing.

8. The actuator mechanism according to claim 1,
wherein the electric motor is provided, and the actuator mechanism comprises an electronic operating circuit (70) that is configured to operate the electric motor.

9. The actuator mechanism according to claim 1, wherein the plurality of toothed parts (31) comprise gearwheels (32) or worms, and the toothed part carriers (34) assigned to the toothed parts comprise gear shafts (34.01) or gear axles.
